(19) United States
(12) Patent Application Publication
(10) Pub. No.: US 2025/0315353 A1
(43) Pub. Date: Oct. 9, 2025

(54) CONTEXT BASED DIAGNOSTICS IN A HETEROGENEOUS COMPUTING PLATFORM

(71) Applicant: Dell Products L.P., Round Rock, TX (US)

(72) Inventors: Ibrahim Sayyed, Georgetown, TX (US); Adolfo S. Montero, Pflugerville, TX (US); Abir Kumar, Bangalore (IN)

(73) Assignee: Dell Products L.P., Round Rock, TX (US)

(21) Appl. No.: 18/625,317

(22) Filed: Apr. 3, 2024

(51) Int. Cl. G06F 11/22

(52) U.S. Cl. CPC G06F 11/2284; G06F 2211/1097

(57) ABSTRACT

Systems and methods include an Information Handling System (IHS) that is adapted to support context-based diagnostics. The IHS may be adapted to determine when a supported diagnostic test has been requested. In response to detecting a request, an operating context of the IHS is determined, such as power status, thermal status and/or status of a user of the IHS. Based on the current operating context of the IHS, the requested diagnostic test is configured to be performed during operation of one or both of a diagnostic boot mode of the IHS and a host operating system of the IHS.

### FIELD

This disclosure relates generally to Information Handling Systems (IHSs), and more specifically, to systems and methods for IHS diagnostics.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

In various embodiments, Information Handling Systems (IHSs) may include: a memory device; and one or more processors coupled to the memory device, wherein the memory device comprises instructions that, upon execution by the processors, cause the IHS to: determine when a diagnostic test supported by the IHS has been requested; determine an operating context of the IHS; and based on the current operating context of the IHS, configure the requested diagnostic test to be performed during operation of one or both of a diagnostic boot mode of the IHS and a host operating system of the IHS.

In some embodiments, execution of the instructions by the processors further causes the IHS to, when a diagnostic boot mode has been configured, boot the IHS to a diagnostic boot mode to perform the diagnostic test on one or more hardware components of the IHS. In some embodiments, the IHS further includes an embedded controller, wherein the diagnostic boot mode boots the IHS to a diagnostic mode supported by the embedded controller. In some embodiments, the operating context of the IHS comprises constrained availability of hardware resources of the IHS that restricts running of the requested diagnostic test during operation of the host operating system of the IHS. In some embodiments, the diagnostic test is performed by the embedded controller, and wherein the diagnostic test is configured to stress test the one or more hardware components of the IHS. In some embodiments, configuration of the requested diagnostic test to be performed both during operation of a diagnostic boot mode and of a host operating system is selected in order to generate training inputs to a diagnostic machine learning system. In some embodiments, results of the diagnostic boot mode are stored to a shared portion of the memory device and are retrieved upon a subsequent booting of the host operating system of the IHS. In some embodiments, the diagnostic boot mode comprises booting a service operating system in order to replicate a reported error. In some embodiments, the service operating system is run by an SoC (System-on-Chip) of the IHS during the diagnostic boot mode. In some embodiments, the operating context of the IHS comprises a power mode in which the IHS is operating. In some embodiments, the operating context of the IHS comprises a thermal status of the IHS. In some embodiments, the operating context of the IHS comprises a status of a user that operates the IHS. In some embodiments, the operating context of the IHS comprises ongoing transport of the IHS.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating examples of components of an Information Handling System (IHS) that is configured, according to some embodiments, to support context-based IHS diagnostics.

FIG. 2 is a diagram illustrating an example of a heterogenous computing platform configured, according to some embodiments, to support context-based IHS diagnostics for an IHS.

FIG. 3 is a diagram illustrating an example of a system, according to some embodiments, for supporting context-based IHS diagnostics.

FIG. 4 is a diagram illustrating an example of a method, according to some embodiments, for supporting context-based IHS diagnostics.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

The terms “heterogenous computing platform,” “heterogenous processor,” or “heterogenous platform,” as used herein, refer to an Integrated Circuit (IC) or chip (e.g., a System-On-Chip or “SoC,” a Field-Programmable Gate Array or “FPGA,” an Application-Specific Integrated Circuit or “ASIC,” etc.) containing a plurality of discrete processing circuits or semiconductor Intellectual Property (IP) cores (collectively referred to as “SoC devices” or simply “devices”) in a single electronic or semiconductor package, where each device has different processing capabilities suitable for handling a specific type of computational task. Examples of heterogenous processors include, but are not limited to: QUALCOMM's SNAPDRAGON, SAMSUNG's EXYNOS, APPLE's “A” SERIES, etc., which typically include ARM core(s).

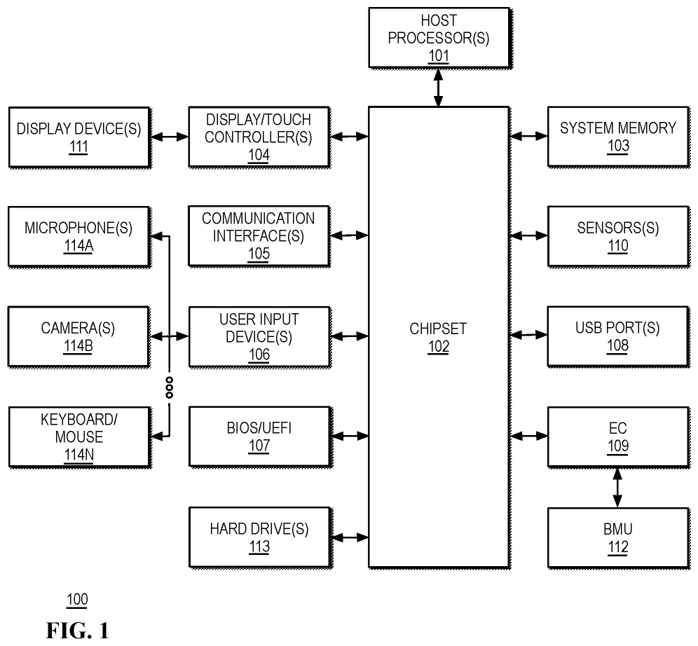

FIG. 1 is a block diagram of components of an IHS (Information Handling System) 100 that, in some embodiments, may include a heterogenous computing platform, as described in additional detail below, and that is configured to support context-based IHS diagnostics, in particular to support diagnostics that are configured and selected based on the context of the IHS's current operation, such as to account for power availability and thermal conditions. Through embodiments, diagnostics may be selected for operation during OS runtime and/or during one or more diagnostic boot modes supported by the IHS 100.

As depicted, IHS 100 includes host processor(s) 101. In various embodiments, IHS 100 may be a single-processor system, or a multi-processor system including two or more processors. Host processor(s) 101 may include any processor capable of executing program instructions, such as an INTEL/AMD x86 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to several resources. In some cases, chipset 102 may utilize a QuickPath Interconnect (QPI) bus to communicate with host processor(s) 101. Chipset 102 may also be coupled to communication interface(s) 105 to enable communications between IHS 100 and various wired and/or wireless networks, such as ETHERNET, WIFI, BLUETOOTH (BT), cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 105 may be used to communicate with peripherals devices (e.g., BT speakers, headsets, etc.). Moreover, communication interface(s) 105 may be coupled to chipset 102 via a Peripheral Component Interconnect Express (PCIe) bus, or the like. Chipset 102 may be coupled to display and/or touchscreen controller(s) 104, which may include one or more or Graphics Processor Units (GPUs) on a graphics bus, such as an Accelerated Graphics Port (AGP) or PCIe bus. As shown, display controller(s) 104 provide video or display signals to one or more display device(s) 111.

Display device(s) 111 may include Liquid Crystal Display (LCD), Light Emitting Diode (LED), organic LED (OLED), or other thin film display technologies. Display device(s) 111 may include a plurality of pixels arranged in a matrix, configured to display visual information, such as text, two-dimensional images, video, three-dimensional images, etc. In some cases, display device(s) 111 may be operate as a single continuous display, rather than two discrete displays.

Chipset 102 may provide host processor(s) 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more USB ports 108, to which one or more peripheral devices may be coupled (e.g., integrated or external webcams, microphones, speakers, etc.). Chipset 102 may further provide host processor(s) 101 with access to one or more hard disk drives, solid-state drives, optical drives, or other removable-media drives 113.

Chipset 102 may also provide access to one or more user input devices 106, for example, using a super I/O controller or the like. Examples of user input devices 106 include, but are not limited to, microphone(s) 114A, camera(s) 114B, and keyboard/mouse 114N. Other user input devices 106 may include a touchpad, stylus or active pen, totem, etc. Each of user input devices 106 may include a respective controller (e.g., a touchpad may have its own touchpad controller) that interfaces with chipset 102 through a wired or wireless connection (e.g., via communication interfaces(s) 105). In some cases, chipset 102 may also provide access to one or more user output devices (e.g., video projectors, paper printers, 3D printers, loudspeakers, audio headsets, Virtual/Augmented Reality (VR/AR) devices, etc.).

In certain embodiments, chipset 102 may further provide an interface for communications with one or more hardware sensors 110. Sensor(s) 110 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), accelerometer, etc.

Basic Input/Output System (BIOS) 107 is coupled to chipset 102. Unified Extensible Firmware Interface (UEFI) was designed as a successor to BIOS, and many modern IHSs utilize UEFI in addition to or instead of a BIOS. Accordingly, as used herein, the term “BIOS” is intended to also encompass UEFI such that these terms may be used interchangeably. In operation, UEFI 107 provides an abstraction layer that allows the OS to interface with certain hardware components of the IHS 100. Upon booting of IHS 100, host processor(s) 101 may utilize program instructions of UEFI 107 to initialize and test hardware components that are coupled to IHS 100, and to load host OS 312 for use by IHS 100. Via the hardware abstraction layer provided by UEFI, software applications executed by host processor(s) 101 and/or SoCs 200 can interface with certain I/O devices that are coupled to IHS 100.

As described in additional detail below, booting of IHS 100 may be conducted according to boot sequence procedures, such as according to a UEFI 107 boot sequence. Operations by UEFI 107, and hardware devices that are accessed via UEFI, may be configured and operated through configuration of UEFI variables. These UEFI variables are stored in a secured NVRAM (Non-Volatile Random-Access Memory) or NVM (Non-Volatile Memory) of the IHS 100. In an IHS 100 that includes a heterogenous computing platform 200, various applications may access UEFI. In addition to access by a host OS 312 of the IHS 100, one or more service OSs 316 may be operated by the heterogenous computing platform 200 and may also access UEFI variables. In some embodiments, UEFI instructions may be used in implementing one or more diagnostic boot modes that operate separate from the OSs 312, 316 of the IHS. As described in additional detail below, the use and configuration of these boot modes may be selected based on the current operating context of the IHS 100.

Embedded Controller (EC) 109 (sometimes referred to as a Baseboard Management Controller or “BMC”) includes a microcontroller unit or processing core dedicated to handling selected IHS operations not ordinarily handled by host processor(s) 101. Examples of such operations may include, but are not limited to: power sequencing, power management, receiving and processing signals from a keyboard or touchpad, as well as operating chassis buttons and/or switches (e.g., power button, laptop lid switch, etc.), receiving and processing thermal measurements (e.g., performing cooling fan control, CPU and GPU throttling, and emergency shutdown), controlling indicator Light-Emitting Diodes or “LEDs” (e.g., caps lock, scroll lock, num lock, battery, ac, power, wireless LAN, sleep, etc.), managing a battery charger and a battery, enabling remote management, diagnostics, and remediation over an OOB or sideband network, etc.

In some embodiments, EC 109 may implement one or more diagnostic boot modes that operate separate from the OSs 312, 316 of an IHS, thus providing diagnostic capabilities that are not affected by the OSs. The diagnostic boot mode of EC 109 may allow certain diagnostic testing of hardware resources that is not fully testable when OSs 312, 316 are operational, such as certain stress tests used to diagnose impending hardware failures. As described in additional detail below, embodiments may request diagnostic tests to be conducted during a diagnostic boot cycle in light of the current resource-constrained operating context of the IHS. Upon a subsequent rebooting of the IHS 100, the requested diagnostic boot mode of EC 109 is invoked and used to perform requested diagnostics on some or all of the hardware of IHS 100. In some embodiments, a diagnostic boot mode may be implemented with only EC 109 in operation and all other hardware of the IHS in testing, diagnostic or other passive modes.

In embodiments, each of the supported diagnostic tests may be performed offline, during one of the supported boot mode, and/or may be performed as operations of the running host OS 312. As described in additional detail below, the decision to perform a diagnostic test during an offline diagnostic boot mode or during the host OS 312 runtime may be based on the current operating context of the IHS 100. In some embodiments, diagnostic tests may be repeated both in a diagnostic boot mode and during the host OS 312 runtime in order to isolate issues arising from the host OS 312 and/or from specific hardware components of an IHS. Additionally or alternatively, embodiments may repeat diagnostic tests in a diagnostic boot mode and during the host OS runtime in order to provide training inputs to a diagnostic machine learning system that may be used in diagnosing and correcting reported errors.

Unlike other devices in IHS 100, EC 109 may be operational from IHS being powered, in particular before other devices are fully running or even powered. As such, EC 109 firmware may be responsible for interfacing with a power adapter to manage the various power states that may be supported by IHS 100. Power operations of the EC 109 may also provide other components of the IHS 100 with power status information for the IHS, such as whether IHS 100 is operating from battery power or is plugged into an AC power source. Firmware instructions utilized by EC 109 may be used to manage other core operations of IHS 100 (e.g., turbo modes, maximum operating clock frequencies of certain components, etc.).

From the perspective of users, IHS 100 may appear to be either “on” or “off,” without any other detectable power states. In some embodiments, however, an IHS 100 may support multiple power states that may correspond to the states defined in the Advanced Configuration and Power Interface (ACPI) specification, such as: S0, S1, S2, S3, S4, S5, and G3. For example, when an IHS 100 is operating in S0 working mode, the IHS is operational, but some hardware components that are not in use may still be individually configured in low power states. In an S0 low-power, idle mode (“Sleep” or “Modern Standby”), an IHS 100 remains partially running with various capabilities of the IHS (e.g., displays, network controllers) may be powered down and other capabilities (e.g., EC, processors) may be in low-power standby modes, thus supporting the ability of the IHS to quickly transition from to a full-power, working S0 mode in response to various events. In the past, S3 was commonly used as a default “Sleep state.” However, many IHSs 100 utilize the described Modern Standby, which may be designated as a hybrid “S0ix” mode, where some or all of the internal hardware of IHS 100 may be placed into their lowest power state, while still supporting code execution that allows fast response and transition of the IHS to a working S0 mode.

An IHS 100 may additionally or alternatively support other low-power modes, such as S1-S3 (that may also be referred to as “Sleep” modes), where the IHS may appear to users to be in an off state. Some IHSs may support only one or two of these states, where the number of distinct states may be a reflection of power saving features of the IHS that have been selected for use. For instance, the amount of power consumed in states S1-S3 is less than S0 and more than S4. An S3 mode consumes less power than S2, and S2 consumes less power than S1. In states S1-S3, volatile memory may be periodically refreshed in order to maintain the operating state of the IHS, with some components remaining powered so that the IHS may wake based on inputs from a keyboard, Local Area Network (LAN), or a Universal Serial Bus (USB) device.

In the S4 state (“Hibernate”), power consumption is reduced to its lowest level. The IHS saves the contents of volatile memory to a hibernation file and some components remain powered, allowing the IHS to wake based on detected input from the keyboard, LAN, or a USB device. “Hybrid sleep” may implemented by some IHSs may use a hibernation file that is used to save the IHS's operating state, and also used to resume the IHSs operations upon reverting to a working S0 mode. “Fast startup” may refer to a power state where the user is logged off before the hibernation file is created, which allows for a smaller hibernation file in IHSs with reduced storage capabilities.

When in the S5 state (“Soft off” or “Full Shutdown”), an IHS 100 is fully shut down without a hibernation file. It occurs when a restart is requested or when an application invokes a shutdown command of the OS, EC 109, etc. During a full shutdown and re-boot, the user session is methodically de-constructed and restarted on the next boot. In some instances, a boot/startup from an S5 state takes significantly longer than resuming from S1-S4 states. At the hardware level, the main difference between S4 and S5 may be that S4 sets a flag on the storage device used to store the hibernation file and configures the bootloader to boot from the flagged hibernation file instead of booting the OS from scratch.

In a G3 (“Mechanical off”) power mode, the IHS 100 may be completely turned off and consumes absolutely no power from its Power Supply Unit (PSU) or main battery (e.g., a lithium-ion battery), with the exception of any Real-Time Clock (RTC) batteries (e.g., Complementary Metal Oxide Semiconductor or “CMOS” batteries, Basic Input/Output System or “BIOS” batteries, coin cell batteries, etc.), which are used to provide power for the IHS's internal clock/calendar and for maintaining certain configuration settings. In some instances, G3 represents the lowest possible power configuration of an IHS from which the IHS can be initialized. From a G3 mode, an IHS may transition to an S5 mode in response to AC power source coupling (i.e., transitioning between battery mode to AC mode). Additionally, or alternatively, an IHS may transition from G3 to S0 based upon the detection of a power button event.

EC 109 firmware may also implement operations for detecting certain changes to the physical configuration or posture of IHS 100 (such as a laptop computer), and may also manage operations of other IHS devices based on the current physical configuration of IHS 100. For instance, when IHS 100 as a 2-in-1 laptop/tablet form factor, EC 109 may receive inputs from a lid position or hinge angle sensor 110, and may use those inputs to determine: whether the two sides of IHS 100 have been latched together to a closed position or a tablet position, the magnitude of a hinge or lid angle, etc. In response to these changes, the EC 109 may enable or disable certain features of IHS 100 (e.g., front or rear facing camera, etc.).

In this manner, EC 109 may identify any number of IHS physical postures, including, but not limited to: laptop, stand, tablet, or book. For example, when an integrated display 111 of IHS 100 is open with respect to a horizontal, face-up position of an integrated keyboard, EC 109 may determine IHS 100 to be in a laptop posture. When an integrated display 111 of IHS 100 is open with respect to a horizontal keyboard portion, but the keyboard is facing down (e.g., its keys are against the top surface of a table), EC 109 may determine IHS 100 to be in a kickstand posture. When the back of an integrated display 111 is closed against the back of the keyboard portion of an IHS, EC 109 may determine IHS 100 to be folded in a tablet posture. When IHS 100 has two integrated displays 111 that are open side-by-side (e.g., in a hybrid laptop with displays in both panels), EC 109 may determine an IHS 100 to be in a book posture. When an IHS 100 is determined to be in a book posture, EC 109 may also determine if the display(s) 111 of IHS 100 are arranged in a landscape or portrait orientation, relative to the user.

In some implementations, EC 109 may be installed as a Trusted Execution Environment (TEE) component to the motherboard of IHS 100. Accordingly, as a component with the root of trusted hardware of IHS 100, EC 109 may be further configured to calculate hashes or signatures that uniquely identify individual components of IHS 100. In such scenarios, EC 109 may calculate a hash value based on the configuration of a hardware and/or software component coupled to IHS 100. For instance, EC 109 may calculate a hash value based on all firmware and other code or settings stored in an onboard memory of a hardware component.

Hash values may be calculated as part of a trusted process of manufacturing IHS 100 and may be maintained in secure storage as a reference signature. EC 109 may later recalculate a hash value based on instructions and settings loaded for use by a hardware component of IHS 100 and may compare the calculated value against the reference hash value to determine if any modifications have been made to the component, thus indicating that the component has been compromised. As such, EC 109 may validate the integrity of hardware and software components installed in IHS 100.

In some embodiments, EC 109 may provide an OOB (Out-Of-Band) or sideband channel that allows an ITDM or Original Equipment Manufacturer (OEM) to manage various settings and configurations of an IHS 100. OOB is used in contradistinction with “in-band” communication channels that operate only after networking 105 other interfaces of the IHS have been initialized, and the OS of the IHS has been successfully booted.

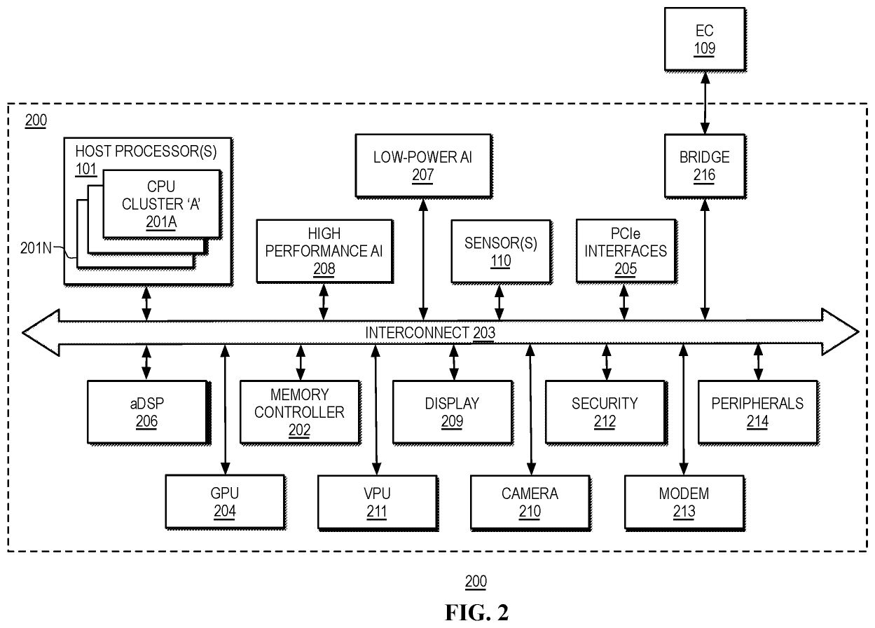

In various embodiments, IHS 100 may be coupled to an external power source through an AC adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 112 may be coupled to EC 109 and it may include, for example, an Analog Front End (AFE), storage (e.g., non-volatile memory), and a microcontroller. In some cases, BMU 112 may be configured to collect and store information, and to provide that information to other IHS components, such as, for EC 109 and/or other devices within heterogeneous computing platform 200 (FIG. 2).

Examples of information collectible by BMU 112 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information (e.g., such as ambient temperature, relative humidity, system geolocation measured by GPS or triangulation, time and date, etc.), etc.

In some embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components, such that all or a portion of the operations executed by the illustrated components may instead be executed by the integrated component.

For instance, in various embodiments, host processor(s) 101 and/or other components shown in FIG. 1 (e.g., chipset 102, display controller(s) 104, communication interface(s) 105, EC 109, etc.) may be replaced by devices within heterogenous computing platform 200 (FIG. 2). As such, IHS 100 may assume different form factors including, but not limited to: servers, workstations, desktops, laptops, appliances, video game consoles, tablets, smartphones, etc.

Historically, IHSs with desktop and laptop form factors have had conventional host OSs executed on INTEL or AMD's “x86”-type processors. Other types of processors, such as ARM processors, have been used in smartphones and tablet devices, which typically run thinner, simpler, and/or mobile OSs (e.g., ANDROID, IOS, WINDOWS MOBILE, etc.). More recently, however, IHS manufacturers have started producing fully-fledged desktop and laptop IHSs equipped with ARM-based, heterogeneous computing platforms. Accordingly, host OSs (e.g., WINDOWS on ARM) have been developed to provide users with a familiar OS experience on those platforms.

FIG. 2 is a diagram illustrating an example of heterogenous computing platform 200 configured to support context-based IHS diagnostics of an IHS 100 in which the platform 200 is installed, in particular where the heterogenous computing platform operates a service OS 316 or other application that may request diagnostic operations and/or that may be used in replicated reported errors, such as during operation of a diagnostic boot mode of the IHS. In various embodiments, heterogenous computing platform 200 may be implemented in one or more SoCs, FPGAs, ASICs, or the like. Heterogenous computing platform 200 may include one or more discrete and/or segregated devices or components, each having a different set of processing capabilities suitable for handling a particular type of computational task. When each device in platform 200 is tasked with executing only the types of computational tasks that it is specifically designed to execute, the overall power consumption of heterogenous computing platform 200 is minimized.

In various implementations, some of the devices in heterogenous computing platform 200 may include their own microcontroller(s) or core(s) (e.g., ARM core(s)) and corresponding firmware. In some cases, a device in platform 200 may also include its own hardware-embedded accelerator (e.g., a secondary or co-processing core coupled to a main core). Each device in heterogenous computing platform 200 may be accessible through a respective Application Programming Interface (API). Additionally, or alternatively, some devices in heterogenous computing platform 200 may execute their own OS. Additionally, or alternatively, one or more of the devices of heterogenous computing platform 200 may be virtual devices and may thus operate virtual machines.

As described in additional detail below, operating systems that run on the heterogenous computing platform 200 may include one more service OSs 316. In some embodiments, service OSs 316 operating on heterogenous computing platform 200 may have access to IHS hardware and may thus have use of diagnostic operations that are supported by the IHS, such as to isolate detected errors by confirming IHS system memory 103 is free from defects, or to confirm a hard drive 113 is operating without defects. As for a host OS 312, when a service OSs 316 is operational, a significant portion of the available hardware resources of an IHS are utilized. In comparison to a host OS 312, a service OS 316 may have limited ability to free resources on an IHS, such as to terminate resource intensive applications being run by the host OS 312. As such, a service OS 316 may be especially limited with regard to performing diagnostic procedures that are not impeded by the significant resource footprint of operating systems running on the IHS. Accordingly, embodiments provide capabilities for diagnostics that may be conducted during operation of the service OS 312 and that may additionally or alternatively be conducted via a diagnostic boot cycle that operates separate from any of the OSs 312, 316 that may operate on an IHS. In embodiments, the decision to run a diagnostic test outside of service OS may be based on context information that characterizes the current resource availability of the IHS.

In some embodiments, heterogenous computing platform 200 includes CPU clusters 201A-N that may correspond to system processor(s) 101, and that are intended to perform general-purpose computing operations. Each of CPU clusters 201A-N may include one or more processing cores and cache memories. In operation, CPU clusters 201A-N are available and accessible to the IHS's host OS 312 (e.g., WINDOWS on ARM) and other applications executed by IHS 100.

CPU clusters 201A-N may be coupled to memory controller 202 via internal interconnect fabric 203. Memory controller 202 may be responsible for managing system memory access for all of devices connected to internal interconnect fabric 203, which may include any communication bus suitable for inter-device communications within an SoC (e.g., Advanced Microcontroller Bus Architecture or “AMBA,” QuickPath Interconnect or “QPI,” HyperTransport or “HT,” etc.). All devices coupled to internal interconnect fabric 203 may communicate with each other and with a host OS executed by CPU clusters 201A-N. In some cases, devices 209-211 may be coupled to internal interconnect fabric 203 via a secondary interconnect fabric (not shown). A secondary interconnect fabric may include any bus suitable for inter-device and/or inter-bus communications within an SoC.

A GPU 204 of the heterogenous computing platform 200 produces graphical or visual content and communicates that content to a monitor or display of the IHS 100 for rendering. In some embodiments, display engine 209 may be designed to perform additional video enhancement operations. In operation, display engine 209 may implement procedures for provide the output of GPU 204 as a video signal to one or more external displays coupled to IHS 100 (e.g., display device(s) 111). PCIe interfaces 205 provide an entry point into any additional devices external to heterogenous computing platform 200 that have a respective PCIe interface (e.g., graphics cards, USB controllers, etc.).

Audio Digital Signal Processor (aDSP) 206 is a device designed to perform audio and speech operations and to perform in-line enhancements for audio input(s) and output(s). Examples of audio and speech operations include, but are not limited to: noise reduction, echo cancellation, directional audio detection, wake word detection, muting and volume controls, filters and effects, etc. In operation, input and/or output audio streams may pass through and be processed by aDSP 206, which can send the processed audio to other devices on internal interconnect fabric 203 (e.g., CPU clusters 201A-N). In some embodiments, aDSP 206 may be configured to process one or more of heterogenous computing platform 200's sensor signals (e.g., gyroscope, accelerometer, pressure, temperature, etc.), low-power vision or camera streams (e.g., for user presence detection, onlooker detection, etc.), or battery data (e.g., to calculate a charge or discharge rate, current charge level, etc.).

Camera device 210 includes an Image Signal Processor (ISP) configured to receive and process video frames captured by a camera coupled to heterogenous computing platform 200 (e.g., in the visible and/or infrared spectrum). Video Processing Unit (VPU) 211 is a device designed to perform hardware video encoding and decoding operations, thus accelerating the operation of camera 210 and display/graphics device 209. VPU 211 may be configured to provide optimized communications with camera device 210 for performance improvements.

Sensor hub 207 may include AI capabilities designed to consolidate information received from other devices in heterogenous computing platform 200, process context and/or telemetry data streams, and provide that information to: (i) a host OS, (ii) other applications, and/or (iii) other devices in platform 200. In collecting data, sensor hub 207 may include General-Purpose Input/Output (GPIOs) that provide Inter-Integrated Circuit (I²C), Improved I²C (I³C), Serial Peripheral Interface (SPI), Enhanced SPI (eSPI), and/or serial interfaces to receive data from sensors (e.g., sensors 110, camera 210, peripherals 214, etc.). Sensor hub 207 may include a low-power core configured to execute small neural networks and specific applications, such as contextual awareness and other enhancements.

High-performance AI device 208 is a significantly more powerful processing device than sensor hub 207, and it may be designed to execute multiple complex AI algorithms and models concurrently (e.g., Natural Language Processing, speech recognition, speech-to-text transcription, video processing, gesture recognition, user engagement determinations, etc.). For example, high-performance AI device 208 may include a Neural Processing Unit (NPU), Tensor Processing Unit (TPU), Neural Network Processor (NNP), or Intelligence Processing Unit (IPU), and it may be designed specifically for AI and Machine Learning (ML), which speeds up the processing of AI/ML tasks while also freeing processor(s) 101 to perform other tasks. Using such capabilities, one or more devices of heterogeneous computing platform 200 (e.g., GPU 204, aDSP 206, sensor hub 207, high-performance AI device 208, VPU 211, etc.) may be configured to execute one or more AI model(s), simulation(s), and/or inference(s).

Security device 212 may include one or more specialized security components, such as a dedicated security processor, a Trusted Platform Module (TPM), a TRUSTZONE device, a PLUTON processor, or the like. In various implementations, security device 212 may be used to perform cryptography operations (e.g., generation of key pairs, validation of digital certificates, etc.) and/or it may serve as a hardware root-of-trust (RoT) for heterogenous computing platform 200 and/or IHS 100.

Modem/wireless controller 213 may be designed to enable wired and wireless communications in any suitable frequency band (e.g., BLUETOOTH or “BT,” WiFi, CDMA, 5G, satellite, etc.), subject to AI-powered optimizations/customizations for improved speeds, reliability, and/or coverage. Peripherals 214 may include any device coupled to heterogenous computing platform 200 (e.g., sensors 110) through mechanisms other than PCIe interfaces 205. In some cases, peripherals 214 may include interfaces to integrated devices (e.g., built-in microphones, speakers, and/or cameras), wired devices (e.g., external microphones, speakers, and/or cameras, Head-Mounted Devices/Displays or “HMDs,” printers, displays, etc.), and/or wireless devices (e.g., wireless audio headsets, etc.) coupled to IHS 100, where configuration of such hardware may be via modifications to UEFI variables corresponding to a respective hardware component.

In some implementations, EC 109 may be integrated into heterogenous computing platform 200 of IHS 100. In other implementations EC 109 may be external to the heterogenous computing platform 200 (i.e., the EC 109 residing in its own semiconductor package) but coupled to integrated bridge 216 via an interface (e.g., enhanced SPI or “eSPI”), thus supporting the EC's ability to access the SoC's internal interconnect fabric 203, including sensor hub 207 and sensor(s) 110. Through this connectivity supported by the interconnect fabric 203, EC 109 may directly access and/or operate most or all of devices 201-216, 110 of the heterogenous computing platform 200.

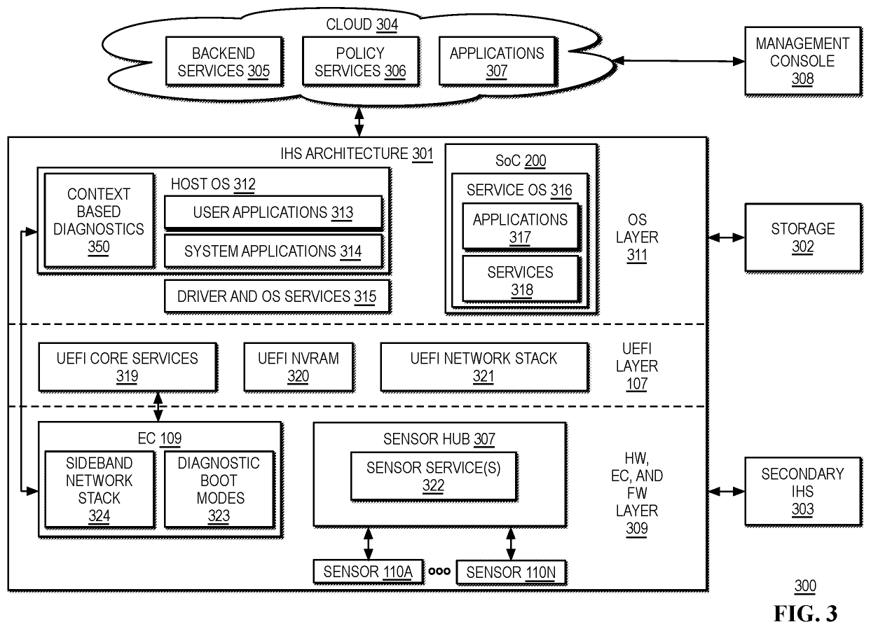

FIG. 3 is a diagram illustrating an example of architecture 300 for supporting context-based IHS diagnostics. Embodiments provide such context-based diagnostic operations in scenarios where applications operated by host OS 312 or operated by the heterogenous computing platform 200, such as a service OS 316, include capabilities for requesting diagnostic operations supported by the IHS. As illustrated, architecture 300 includes IHS 301 (e.g., implementing aspects of IHS 100 and/or platform 200) coupled to storage device 302 (e.g., NVMe, SSD, etc.), secondary or companion IHS 303 (e.g., a smart phone, a laptop, etc.), and cloud or remote services 304. Cloud 304 may include backend or remote services 305, policy services 306, and web applications 307. In some cases, components of cloud 304 may be accessible to IHS 301 and/or secondary IHS 303, and configurable via ITDM management console 308. IHS architecture 301 may include hardware/EC/firmware layer 309, UEFI layer 107, and OS layer 311.

OS layer 311 includes a host OS (Operating System) 312 that is executed by host processor(s) 101. A variety of software applications may operate within the OS 312, where these applications may include user applications 313 and system applications 314, one or more OS telemetry applications 350. OS layer 311 may also include various drivers and other core OS operations, such as the operation of a kernel. In some embodiments, booting of the host OS 312 is selected based on selection of a boot device that includes the host OS boot code during the boot sequence of the IHS 100. In many instances, this boot device that includes instructions for booting the host OS 312 is the default boot device of the IHS 100.

As described, various components of a heterogenous computing platform may independently run their own operating systems, such as a service OS 316 that is run by an SoC 200 that is used to implement the heterogenous computing platform. Within IHS architecture 301, some of these discrete operating systems operated by the heterogenous computing platform 200 may be considered service OSs 316, where each service OS may each include its own applications 317 and services 318. In some embodiments, host OS 312 and/or service OS 316 may request the running of hardware diagnostic operations supported by IHS 100, such as IHS system memory 103 and storage drive 113, 302 diagnostics. However, the ability of these IHS diagnostic operations to fully test the hardware resources of the IHS may be significantly impeded by the considerable hardware resources used in the operation of host OS 312 and/or service OS 316, even when the OSs are idle.

Nonetheless, in many instances, diagnostics are advantageously conducted during normal operations of the IHS, with host OS 312 and/or service OS 316 are running. Moreover, in scenarios where machine learning systems are used in identification of hardware or software of the IHS 100 that is the root cause of a reported issue that is being diagnosed, the training of such machine learning systems may benefit from some or all of the diagnostic evaluations being conducted during operation of host OS 312, and also conducted offline using one of the supported diagnostic boot modes, which may utilize a service OS 316 to simulate the host OS 312 during the boot mode. Although diagnostics may be improved through evaluation of different scenarios, such as stress testing components in varying conditions, conducting some diagnostic evaluations may negatively impact the user experience. Accordingly, embodiments provide contextual diagnostics 350 that evaluate the different diagnostics that are available and based on the current operating context of the IHS 100, an appropriate diagnostic evaluation is selected and configured based on current operating conditions. As described in additional detail below, based on context determinations, the requested diagnostics may conducted during the host OS 312 runtime and/or during a diagnostic boot mode 323 supported by EC 109.

UEFI layer 107 may include UEFI core services 319, UEFI NVRAM 320, and UEFI network stack 321. UEFI core services 319 may include operations for identifying and validating the detected hardware components of an IHS. Portions of NVRAM 320 may be utilized to store core UEFI instructions and to store variables that are used to set UEFI boot and runtime variables that may be used to configure settings of individual hardware components of an IHS 100, such as configurable firmware operations of hardware components. As described in additional detail below, these UEFI variables may be extended for use in requesting a diagnostic boot cycle and in specifying requested diagnostic operations to be performed as part of the next diagnostic boot cycle. As described in additional detail below, the configurations of diagnostic tests using these UEFI variables may be selected based on the current operating context of the IHS 100.

The UEFI network stack 321 may be utilized during initialization of the IHS in support of validation procedures, such as in retrieving reference signatures corresponding to authentic firmware instructions for hardware components of an IHS 100. UEFI core service 319 may also include operations for interfacing with certain hardware of an IHS, in particular user I/O hardware devices 350. As described in additional detail below, UEFI core services 319 may also include instructions for booting IHS 100. In some embodiments, the UEFI core services 319 may also include instructions that implement the described boot sequence operations that support diagnostic boot cycles.

As illustrated, IHS architecture 301 also includes a hardware/EC/firmware layer 309 that includes EC 109 and sensor hub 207. As described above, EC 109 may implement a variety of procedures for management of individual hardware of an IHS 100 and of the IHS itself, including management of the various power states that are supported by the IHS. EC 109 is configured to execute one or more sensor services that interface with sensor hub 207 in implementing various features of an IHS 100, such response to user-presence determination by the sensor hub 207 that is acted upon by the EC 109 in initiation heightened security protocols. As described, EC 109 may interface with some or all of the individual hardware components/systems of an IHS via sideband management channels that are separate from inline communication channels used by the host processor 101 and SoCs.

As indicated in FIG. 3, EC 109 may support one or more diagnostic boot modes 323, in particular diagnostic boot modes by which EC may run diagnostic tests without booting any of host OS 312, SoC 200 or host OS 316. As described above, EC 109 may operate from a separate power plane from the main system resources of an IHS, such as processors 101 and heterogenous computing platform 200. Accordingly, EC 109 may implement diagnostic operations that may run when all other hardware is idle, with no applications other than the diagnostic boot mode of the EC operating on IHS 100. Through use of such boot modes, EC 109 may provide diagnostic operations that are selected base on the current operating context of the IHS 100. For instance, certain stress tests used in evaluation of degraded performance by a hardware component may be conducted during an offline diagnostic boot mode in order to avoid any impacts to the user.

As described above, sensor hub 207 may receive inputs from some or all of the sensors 110A-N of an IHS 100. Sensor hub 207 may implement a variety of sensor service(s) 322 for communicating with and collecting data from sensors 110A-N. In some embodiments, sensor hub 207 may implement shock detection procedures that may incorporate inputs from inertial and other sensors 110A-N of an IHS. Such shock detection procedures may detect shocks experienced by an IHS 110 and may characterize and assess detected shocks in evaluating possible damage to the IHS.

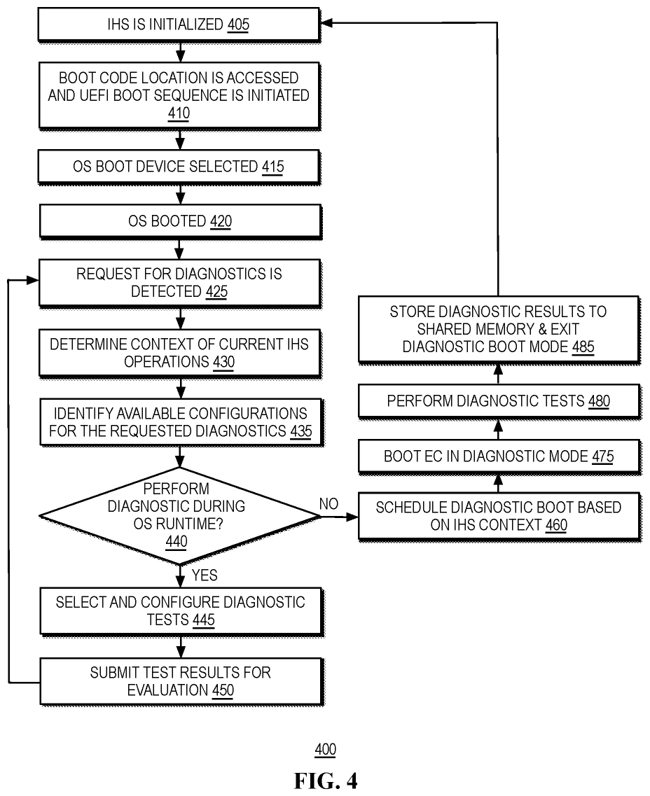

FIG. 4 is a diagram illustrating an example of a method, according to some embodiments, for supporting context-based IHS diagnostics. Embodiments may thus begin, at 405, with the initialization of an IHS 100 that includes a heterogenous computing platform 200. Upon being powered, at 410, secured boot instructions are accessed in order to initialize a host processor 101 and to locate instructions, in some embodiments stored in UEFI NVRAM 320, for initiating a UEFI boot sequence. The UEFI boot sequence may be described as a series of phases, where successful completion of one phase is generally required for the operation of subsequent phases of the boot sequence.

In some embodiments, the described support for context-based diagnostics may include support for diagnostic boot cycles that may be implemented in part via UEFI boot code that is retrieved from UEFI NVRAM 320 upon initialization of the IHS. The boot instructions of the initial phase of the UEFI boot sequence may be used to validate the authenticity of host processor(s) 101, chipset 102, and the motherboard on which the processor is mounted. In the next phase of the UEFI boot sequence, the execution of UEFI 107 boot code retrieved from UEFI NVRAM 320 enters the PEI (Pre-EFI Initialization) phase. During this phase, initialization of authenticated host processor(s) 101, chipset 102 and the motherboard is completed, along with the initialization of system memory 103.

The UEFI boot sequence also includes the Driver Execution (DXE) phase, where images of bus and core hardware device drivers are retrieved. The core drivers that are loaded at this point may be a minimal set required to support boot operations. With core hardware and bus drivers loaded and operating in this manner, the BDS (Boot Device Selection) phase is initiated and is used to identify the boot device that will be used to continue booting. In some embodiments, one or more diagnostic boot modes may be available, where the diagnostic boot mode that is selected and the settings that are used in the boot mode are selected based on the current operating context of the IHS 100.

In non-diagnostic scenarios, the IHS will be booted to the host OS 312 and the IHS is available for operation by the user. Accordingly, at 415, the host OSs 312 is selected as the boot device. The boot sequence continues, at 420, with the retrieval of host OS 312 boot code and the use of these instructions to boot the OS. Whether as part of the booting of the host OS, or after completing booting of the OS, embodiments may determine whether diagnostic results are available from a previous diagnostic boot cycle. In some diagnostic boot cycles supported by embodiments, diagnostic results generated during a diagnostic boot mode may be written to a shared memory location, such as a shared location of NVRAM 320. Upon booting of the host OS 312, the diagnostic boot mode results may be retrieved and used in diagnostic evaluation of the results, such as in use and/or training of diagnostic machine learning system.

With the host OS 312 booted and operating, IHS 100 may operate for any amount of time until, at 425, a request is detected for diagnostic operations that are supported by the IHS. In some embodiments, the diagnostic operations may be requested by a system application 314 of a host OS 312, such as a request for memory diagnostics by the kernel of the OS. In some embodiments, the diagnostic operations may be requested by a user application 313 of a host OS 312, such as a request for network controller diagnostics to be performed in order to isolate identified network errors. In some embodiments, the diagnostic operations may be requested by a manual input from a user of the IHS 100, or by an administrator operating a remote console 308 in remote management of the IHS. In some embodiments, the diagnostic operations may be requested by a diagnostic system that utilizes a machine learning system. In diagnosing a specific issue, such as a repeated memory error, such a diagnostic machine learning system may request specific diagnostic tests using specific test settings to be performed on an IHS. In training the machine learning system, each diagnostic operation, whether successful in identifying a root cause issue or not, present a training opportunity that may be advantageously used through the operation of embodiments without negative impacts to the user and/or to ongoing operations of the IHS.

Once a request for a diagnostic operation has been detected, at 430, embodiments may determine the current operating context of the IHS 100. In some scenarios, diagnostic tests may be conducted without affecting user operations, but in other scenarios, running resource-intensive diagnostic tests may significantly impact the ability of the IHS to support user operations. As described, some supported diagnostic tests may purposefully maximize use of hardware and/or software of the IHS 100, such as stress tests seeking to replicate or otherwise diagnose specific issues that have been reported. Such stress tests may be expected to affect the user experience if these stress tests are run during the host OS runtime. In addition to stress tests, other supported diagnostic tests may otherwise affect the operation of the IHS, such as diagnostic tests that activate a diagnostic mode by a network controller that includes additional error checking and logging, thus slowing the user operations that can be supported by the network controller. Accordingly, some types of diagnostic tests may be advantageously scheduled and configured by embodiments to operate offline, or may be configured to be run during the host OS runtime using settings that reduce possible impacts of the test, where such determinations may be based on the current operating context of the IHS 100.

Embodiments may consider a wide variety of context information regarding the current status of the IHS 100 when determining when to run a requested diagnostic test, and the settings to be used in the diagnostic test. Some embodiments may consider the power status of the IHS 100. As described above, an IHS 100 may be a portable device such as a laptop computer that may be operated from power drawn from internal rechargeable batteries of the IHS. In some embodiments, resource-intensive diagnostic tests may be deferred until an IHS is plugged into a power source, while allowing other diagnostic tests, such as initiating diagnostic monitoring of communications in search of transmissions received by a network controller from a malicious process that is being investigated.

In some embodiments, context information may include the current thermal context of the IHS's operations. For instance, temperature readings may indicate that any diagnostic test that is initiated must not cause additional thermal stress if the test is to be conducted in the current operating context, with the host OS 312 operating. Such temperature readings may measure temperatures at specific internal locations within an IHS, such as at a heatsink, or reported by a specific hardware component, such as temperatures reported by a storage device or network controller, or reported by an ambient temperature sensor. In some embodiments, resource-intensive diagnostic tests may be configured to have minimal thermal impact in thermal contexts with a small thermal margin, or may deferred for operation during a diagnostic boot mode in which thermal stress tests may be conducted in a controlled logical environment.

In some embodiments, context information may include the current user context of the IHS's operations. In scenarios where a user is actively operating the IHS, diagnostic tests that will affect the user experience are undesirable. If a user is holding a portable IHS, diagnostic tests are undesirable if they could result in noticeable heating of the outer skin of the IHS. If a user is in close proximity to the IHS 100, diagnostic tests are undesirable if they could result in fan noise. If a user is operating an the IHS 100 during a regular period of heavy use, diagnostic tests are undesirable if they could impact the operation of the IHS. If the IHS is in transport, such as within a closed bag, diagnostic tests that cause the IHS to generate additional heat are undesirable.

Once context information has been collected, at 435, embodiments may identify the diagnostic tests and settings that are available for configuration in order to account for the current operating context of the IHS 100. As described, some diagnostics tests may designated to be conducted during a diagnostic boot mode and thus with maximal use of the hardware resources of the IHS 100, and without impacting user operation of the IHS. Such stress tests may be run most extensively and maximally when conducted when the IHS context is one where the IHS is idle and thus where the user is not using the IHS or even in close proximity to the IHS. In some instances, embodiments may thus schedule a diagnostic stress test for intervals where the IHS is regularly idle. Embodiments may thus schedule some diagnostic stress tests for idle intervals and may configure the duration and intensity of these tests based on the specific contextual factors. For example, embodiment may schedule diagnostic tests that could cause heating of the external skin of the IHS to situations where the IHS is idle and can be confirmed as not in transit, and thus not in an enclosed space. Similarly, embodiments may schedule a diagnostic test that generates significant heat to be conducted when the IHS can be confirmed as being at a known location of regular use, such as at a place of employment and thus less likely to be in a poorly ventilated location, as opposed to a home setting.

Diagnostic boot modes may be used to diagnose a variety of issues. In some instances, diagnostic evaluations may completed using only boot mode, but others may additionally or alternatively require diagnostics to be performed during operation of the host OS 312. As such, in some instances, diagnostic operations may be repeated by embodiments both during operation of the host OS 312 and during a diagnostic boot mode. In some embodiments, diagnostic operations may be conducted using an OS during a diagnostic boot mode. For example, embodiments may support a diagnostic boot mode that includes booting of a service OS 316 that is run by an SoC, thus providing an operational OS that may be used for diagnostic testing during a supported diagnostic boot mode, such as to replicate errors in order to identify a root cause for a reported error.

In other instances, diagnostic tests are preferably conducted during normal host OS 312 operations, such as to diagnose specific operating system applications and/or user actions as the possible root of cause of reported issues. However, in light of the expected resource contention during operation of the host OS and in light of the possibility of the user actively operating the IHS during some intervals of the day, embodiments may select diagnostic test settings that result in less resource-intensive diagnostic test being performed during the host OS runtime. For instance, while a component may be more strenuously stress tested during a diagnostic boot cycle, that same stress test may be performed with less resource intensive settings when performed during host OS 312 runtime. In some embodiments, stress testing may be limited to short intervals when conducted during host OS runtime in comparison to the duration of boot mode stress tests. In some embodiments, stress testing during operation of the host OS 312 may be delayed until user operation of the IHS is determined to be sporadic rather than continuous, such that a diagnostic evaluation is more likely to be completed without significantly impeding the user's operation of the IHS.

Upon selecting a diagnostic operation and the configurations to be used, at 440, embodiments determine whether the diagnostics will be performed during host OS 312 runtime and/or during a diagnostic boot mode supported by the IHS. If a diagnostic test will be run both during a diagnostic boot mode and during the host OS 312 runtime, embodiments may initiate the host OS 312 diagnostic tests immediately, if the current operating context of the IHS can accommodate immediate testing via the host OS. In some instances, the host OS runtime diagnostic tests may be delayed until the operating context can better accommodate the testing. In some instances, the operating context may allow for immediate re-initialization of the IHS to a diagnostic boot mode, such as in scenarios where the request for diagnostics is generated by an automated diagnostic system while the IHS is idle. In other instances, diagnostic boot mode operations may be delayed until the IHS is idle.

In scenarios where the operating context of the IHS dictates that requested diagnostics should performed offline through operation of a boot cycle, some embodiments may encode the a diagnostic operation to be performed and the configurations to be used within one or more UEFI variables. In some embodiments, a UEFI variable may be designated for signaling a request for a specific diagnostic boot mode as part of the next boot cycle, such as boot modes enabling diagnostics of IHS system memory 103, network controller 105, main processor 101, storage drive 113, SoCs, and/or other hardware of an IHS 100. In some embodiments, multiple additional UEFI variables may be designated for specifying specify diagnostic tests and settings to be used in each test, where the diagnostic tests and settings are selected based on the current operating context of the IHS 100.

Once encoded in this manner, the requested diagnostic operations can be performed upon the next boot cycle of the IHS 100, in light of the current operating context of the IHS that preclude the diagnostic test from being performed during the host OS runtime. In some instances, the boot cycle may be initiated immediately, such as in scenarios where the diagnostic operations have been requested by the host OS 312 application by which a user that is operating the IHS 100 has requested the diagnostic operations to be conducted immediately and has confirmed an immediate restart of the IHS. In some instances, the current operating context of the IHS may dictate that the diagnostic boot cycle should be initiated at a later time, such as during a daily interval when the IHS is rarely used.

Whether initiated immediately or at a scheduled time, the boot sequence of the IHS is re-initiated, with the IHS configured to boot to the context-selected, diagnostic boot mode. As described above, the boot sequence of an IHS 100 may include several phases, including the selection of a boot device. In a typical boot cycle of the IHS, boot device selection reverts to booting of the host OS 312. However, in some embodiments, the boot device selection phase of the boot sequence may query the UEFI diagnostic variables in order to determine whether a diagnostic boot cycle has been requested. Based on the queries, embodiments may determine that no diagnostic boot cycle request is present in the UEFI variables and may continue by booting the host OS 312 as the default boot device.

In scenarios where the UEFI variables indicate a diagnostic boot cycle has been requested, at 475, a diagnostic boot mode of EC 109 may be launched instead of booting to the host OS 312. The UEFI boot sequence may thus identify and load instructions for booting EC 109 in the diagnostic boot mode that is requested via the UEFI variables. In some embodiments, EC 109 may support distinct boot modes for different diagnostic operations, such as a memory diagnostic boot mode and/or a processor diagnostic boot mode. In some embodiments, a single EC 109 boot mode may support all diagnostic operations that may be requested using UEFI variables.

With EC 109 initialized in the requested diagnostic boot mode, at 480, the capabilities of the EC are used to perform the diagnostic operations, where the diagnostic operations that are conducted may be selected based on requests specified by the host OS 312 and/or service OS 316 and subsequently encoded within UEFI variables. As described, EC 109 may support sideband signaling pathways by which EC may provide remote management of IHS 100 and of individual hardware components of IHS 100. EC 109 may also operate while other hardware of the IHS operates in a low-power or standby mode, thus allowing the EC to conduct diagnostic tests supported by the hardware, all while having exclusive use of this hardware and thus able to fully test the capabilities of the hardware.

The requested diagnostic operations may generate a variety of results that may be encoded within shared data structures as part of the diagnostic boot mode. In some embodiments, at 485, these data structures encoding the diagnostic results may be stored to a dedicated partition of UEFI NVRAM 320. In some embodiments, the diagnostic results may be stored to the UEFI NVRAM 320 by EC 109 directly as part of the diagnostic boot mode, with the diagnostic boot mode exiting upon writing the diagnostic results to the UEFI NVRAM. Upon exiting the diagnostic boot mode, embodiments may map the diagnostic results stored in the UEFI NVRAM 320 to entries in the ACPI table that is utilized by the IHS, and in particular an ACPI table used by host OS 312 and/or service OS 316.

With the diagnostic results mapped to ACPI table entries, embodiments may reset the UEFI variables used to request the diagnostic boot cycle. In particular, the UEFI variables specified by the host OS 312 and/or service OS 316 in requesting the current diagnostic boot mode are reset such that the boot device selection operations in the next boot sequence do not initiate another diagnostic boot mode. Once reset in the manner, the UEFI variables do not trigger diagnostic boot mode again until another diagnostic boot cycle is requested and selected based on the operating context of the IHS.

Once the UEFI variables used to request a diagnostic boot cycle have been reset, at 405, the IHS is again reinitialized. As describe above, the IHS boot sequence may include several phases. Boot code is retrieved and the boot device is selected. With the resetting of the UEFI diagnostic boot cycle variables, the boot device selection phase of the boot sequence selects the OS boot device and the OS is booted. Once the OS has been booted, the OS determines whether diagnostic results are available. In some embodiments, the OS queries the ACPI table entries designated for providing diagnostic results. As described, this ACPI table may be populated as part of the diagnostic boot mode.

In scenarios where diagnostic test is performed during host OS runtime, at 445, the configured test is run, and at 450, the results are submitted for evaluation. Whether the diagnostic tests have been run during the host OS runtime or during a boot mode, embodiments may utilize the results of the tests in the use and training of a diagnostic machine learning system. In some embodiments, the diagnostic machine learning system may be configured to received diagnostic test results as inputs, such as inputs nodes of a neural network, with different input nodes provided for diagnostic tests that are conducted during the host OS runtime and other input nodes provided for test results from diagnostic boot modes, thus supporting parallel evaluation by the neural network of both types of tests in diagnosing a reported error.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
a memory device; and
one or more processors coupled to the memory device, wherein the memory device comprises instructions that, upon execution by the processors, cause the IHS to:
determine when a diagnostic test supported by the IHS has been requested;
determine an operating context of the IHS; and
based on the current operating context of the IHS, configure the requested diagnostic test to be performed during operation of one or both of a diagnostic boot mode of the IHS and a host operating system of the IHS.

2. The IHS of claim 1, execution of the instructions by the processors further causes the IHS to, when a diagnostic boot mode has been configured, boot the IHS to a diagnostic boot mode to perform the diagnostic test on one or more hardware components of the IHS.

3. The IHS of claim 2, further comprising an embedded controller, wherein the diagnostic boot mode boots the IHS to a diagnostic mode supported by the embedded controller.

4. The IHS of claim 2, wherein the operating context of the IHS comprises constrained availability of hardware resources of the IHS that restricts running of the requested diagnostic test during operation of the host operating system of the IHS.

5. The IHS of claim 3, wherein the diagnostic test is performed by the embedded controller, and wherein the diagnostic test is configured to stress test the one or more hardware components of the IHS.

6. The IHS of claim 1, wherein configuration of the requested diagnostic test to be performed both during operation of a diagnostic boot mode and of a host operating system is selected in order to generate training inputs to a diagnostic machine learning system.

7. The IHS of claim 1, wherein results of the diagnostic boot mode are stored to a shared portion of the memory device and are retrieved upon a subsequent booting of the host operating system of the IHS.

8. The IHS of claim 1, wherein the diagnostic boot mode comprises booting a service operating system in order to replicate a reported error.

9. The IHS of claim 8, wherein the service operating system is run by an SoC (System-on-Chip) of the IHS during the diagnostic boot mode.

10. The IHS of claim 1, wherein the operating context of the IHS comprises a power mode in which the IHS is operating.

11. The IHS of claim 1, wherein the operating context of the IHS comprises a thermal status of the IHS.

12. The IHS of claim 1, wherein the operating context of the IHS comprises a status of a user that operates the IHS.

13. The IHS of claim 1, wherein the operating context of the IHS comprises ongoing transport of the IHS.

14. A method for context-based diagnostic by an Information Handling System (IHS), the method comprising:
determining when a diagnostic test supported by the IHS has been requested;
determining an operating context of the IHS; and
based on the current operating context of the IHS, configuring the requested diagnostic test to be performed during operation of one or both of a diagnostic boot mode of the IHS and a host operating system of the IHS.

15. The method of claim 14, further comprising, when a diagnostic boot mode has been configured, booting the IHS to a diagnostic boot mode to perform the diagnostic test on one or more hardware components of the IHS.

16. The method of claim 15, wherein the diagnostic boot mode boots the IHS to a diagnostic mode supported by an embedded controller of the IHS.

17. The method of claim 13, wherein the operating context of the IHS comprises at least one of: a power mode in which the IHS is operating, a thermal status of the IHS, a status of a user that operates the IHS and ongoing transport of the IHS.

18. An storage device having instructions stored thereon, wherein execution of the instructions by one or more processors of an IHS (Information Handling System) causes the processor to:
determine when a diagnostic test supported by the IHS has been requested;
determine an operating context of the IHS; and
based on the current operating context of the IHS, configure the requested diagnostic test to be performed during operation of one or both of a diagnostic boot mode of the IHS and a host operating system of the IHS.

19. The storage device of claim 18, execution of the instructions by the processors further cause the IHS to, when a diagnostic boot mode has been configured, boot the IHS to a diagnostic boot mode to perform the diagnostic test on one or more hardware components of the IHS.

20. The storage device of claim 18, wherein the operating context of the IHS comprises at least one of: a power mode in which the IHS is operating, a thermal status of the IHS, a status of a user that operates the IHS and ongoing transport of the IHS.
